(19) United States
(12) Patent Application Publication
(10) Pub. No.: US 2016/0323430 A1
(43) Pub. Date: Nov. 3, 2016

(54) Mounting Device

(71) Applicant: Patrick J. Fiori, Indianapolis, IN (US)

(72) Inventor: Patrick J. Fiori, Indianapolis, IN (US)

(21) Appl. No.: 15/109,197

(22) PCT Filed: Jan. 29, 2015
(86) PCT No.: PCT/US15/13470

§ 371 Date: Jun. 30, 2016

Related U.S. Application Data
(60) Provisional application No. 61/934,733, filed on Feb. 1, 2014.
(60) Provisional application No. 61/989,069, filed on May 6, 2014.

(51) Int. Cl. H04M 1/04; H04M 1/02; H04B 1/3877

(52) U.S. Cl. CPC H04M 1/04; H04B 1/3877; H04M 1/0214

(57) ABSTRACT

A mounting device for supporting a hand-held computer, the mounting device including a housing that is operationally configured to support a handheld computer.

### CROSS-REFERENCE TO RELATED APPLICATIONS

This application claims priority to U.S. Provisional Patent Application Ser. No. 61/934,733, filed Feb. 1, 2014, and U.S. Provisional Patent Application Ser. No. 61/989,069, filed May 6, 2014, the contents of which are incorporated herein by reference.

### BACKGROUND AND SUMMARY OF THE DISCLOSURE

The present disclosure relates to mounting devices. More particularly, the present disclosure relates to mechanical mounting devices for handheld computers, for example smartphones and tablet computers.

Some mounting devices for electronics are used to support, carry and protect a handheld computer in a number of ways. For example, a user may want to support a handheld computer on a number of surfaces and in a number of environments without limiting the functionality of the device.

In one embodiment of the present disclosure, a mounting device is provided for supporting a handheld computer. The mounting device includes a housing that is operationally configured to releasably support a handheld computer. The housing has a top portion, a bottom portion, a first side portion, and a second side portion. The mounting device further includes at least one articulated assembly attached to the housing through a connecting joint. The at least one articulated assembly includes a plurality of articulated members. At least one of the plurality of articulated members is biased to at least partially form a rear surface of the mounting device. A second of the plurality of articulated members is positioned distal to a first of the plurality of articulated members relative to the connecting joint.

In another embodiment of the present disclosure, a mounting device is provided for supporting a handheld computer. The mounting device includes a housing that is operationally configured to releasably support a handheld computer. The housing has a top portion, a bottom portion, a first side portion, a second side portion and a rear portion. The rear portion of the housing includes a recess. The mounting device further includes at least one articulated assembly attached to the housing through a connecting joint. The at least one articulated assembly includes at least a first articulated member, a second articulated member, and a last articulated member. The second articulated member is positioned distal to the first articulated member relative to the connecting joint. The last articulated member is positionable to be at least partially received in the recess.

Additional features of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The foregoing aspects of this disclosure will become more readily appreciated as the same becomes better understood by reference to the following detailed description when taken in conjunction with the accompanying drawings.

FIG. 1 is a perspective rear view of a first embodiment of a mounting device according to the present disclosure;

FIG. 2 is an exploded view of the mounting device of FIG. 1;

FIG. 3 is a perspective front view of the mounting device of FIG. 1 with an articulated assembly shown in a standing configuration;

FIG. 4 is a perspective rear view of the mounting device of FIG. 1 in a default mode;

FIG. 5 is a perspective rear view of a second embodiment of a mounting device according to the present disclosure, with an articulated assembly shown in a standing configuration;

FIG. 6 is a perspective front view of the mounting device of FIG. 5 in a default mode;

FIG. 7 is a perspective front view of the mounting device of FIG. 5, with the articulated assemblies shown in various positions;

FIG. 8 is a perspective rear view of a third embodiment of a mounting device according to the present disclosure in a default mode;

FIG. 9 is a perspective front view of the mounting device of FIG. 8, with an articulated assembly shown in a various position;

FIG. 10 is a perspective front view of a fourth embodiment of a mounting device according to the present disclosure with a handheld computer mounted thereto;

FIG. 11 is a perspective rear view of the mounting device of FIG. 10 in a default mode;

FIG. 12 is a cross-sectional view of the mounting device of FIG. 10 taken along line 12-12 of FIG. 11;

FIGS. 13A-13D are perspective rear views of a fifth embodiment of a mounting device according to the present disclosure, with an articulated assembly thereof shown in various positions;

FIG. 14 is an exploded view of the mounting device shown in FIGS. 13A-13D;

FIG. 15 is an exploded view of a sixth embodiment of a mounting device according to the present disclosure, showing parts of the articulated assembly thereof;

FIG. 16 is a partial view of the mounting device of FIG. 15, with the articulated assembly clamped to an exterior object;

FIG. 17 is a perspective side view of the mounting device of FIG. 15, with the articulated assembly shown in a standing configuration;

FIG. 18 is a perspective rear view of a seventh embodiment of a mounting device according to the present disclosure, with an articulated assembly separated from a rear portion of a housing; and

FIG. 19 is a perspective side view of the mounting device of FIG. 18, with the articulated assembly shown in a standing configuration.

Corresponding reference characters indicate corresponding parts throughout the several views. Unless otherwise indicated, the various features and components of the drawings are proportional. The exemplifications set out herein illustrate embodiments of the disclosure, and such exemplifications are not to be construed as limiting the scope of the disclosure in any manner.

### DETAILED DESCRIPTION OF THE DRAWINGS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

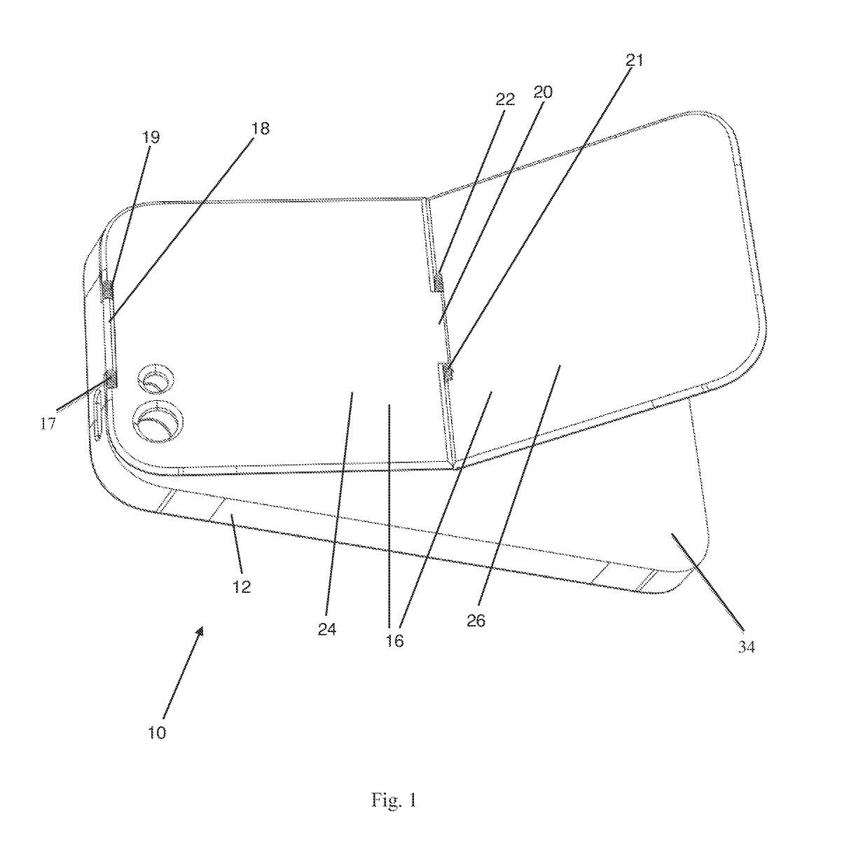

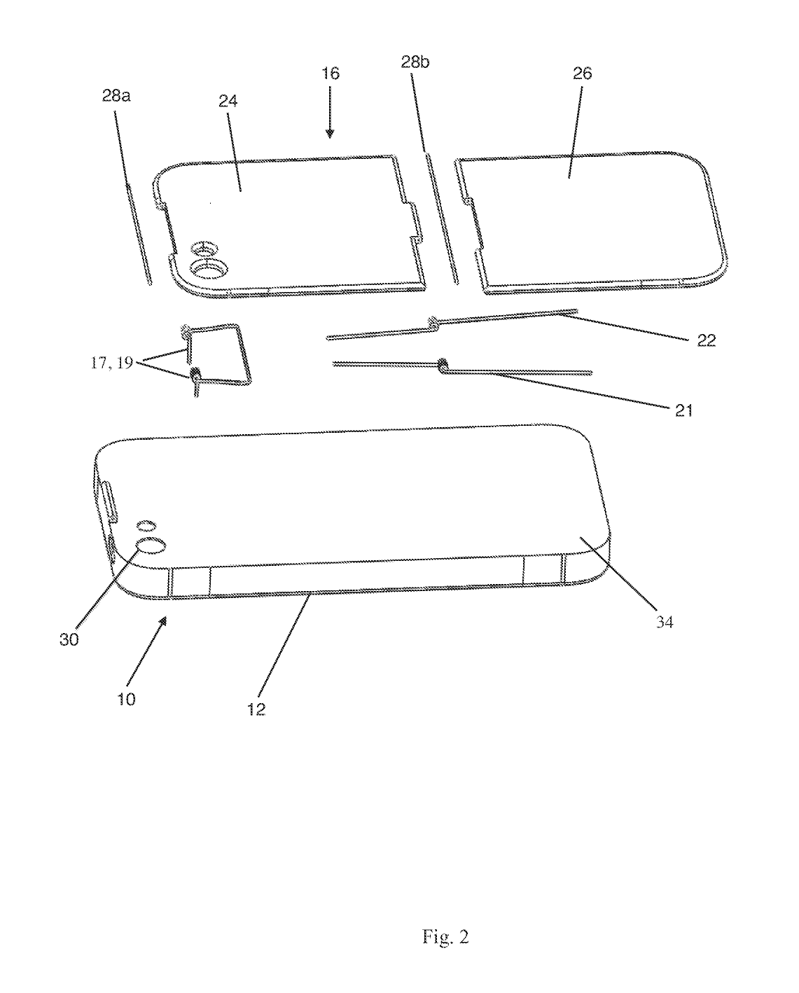

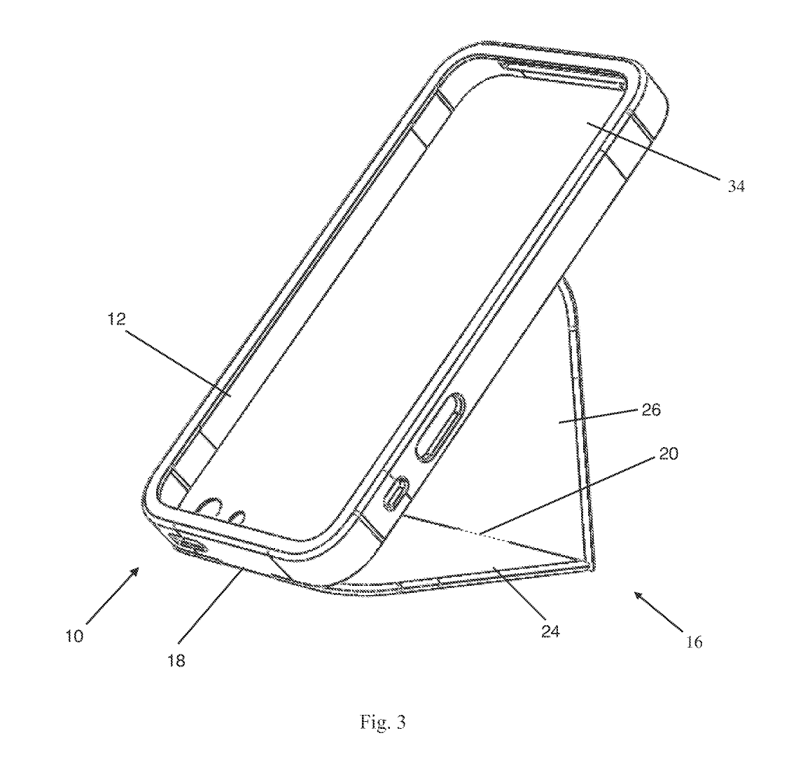

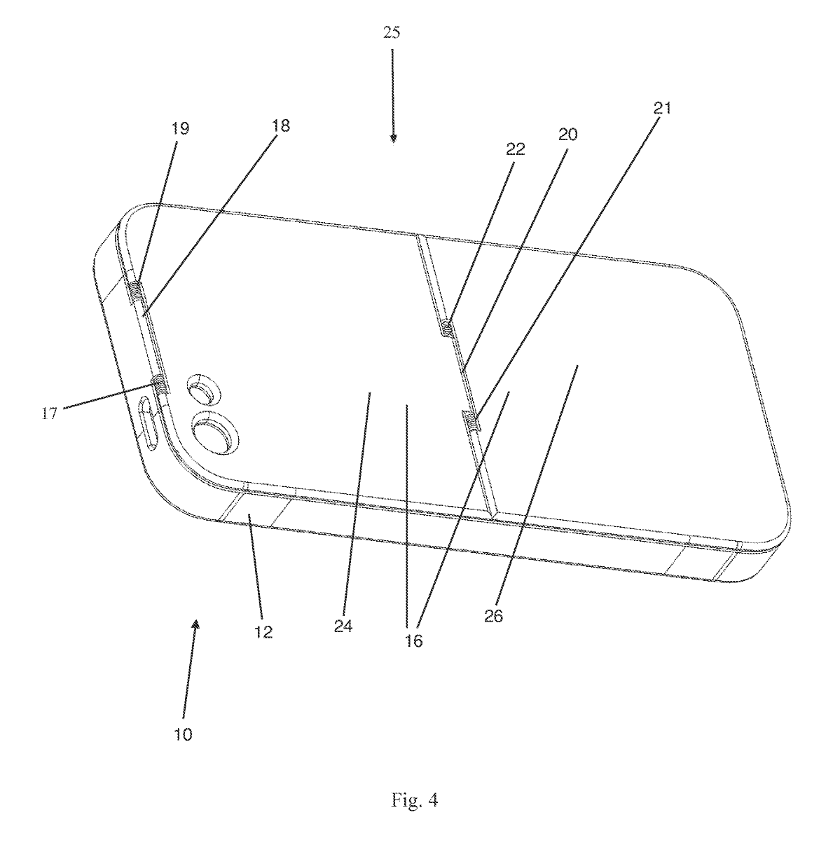

Referring now to a first embodiment of a mounting device in accordance with the present disclosure, FIGS. 1-4 show a mounting device 10 having a housing 12 for generally enclosing at least a portion of a handheld computer and also including an articulated assembly 16 that is biased toward a rear portion 34 of housing 12 by a connecting joint 18 with at least one spring, for example built-in torsion springs 17, 19 and a linking joint 20 with at least one spring, for example built-in torsion springs 21, 22.

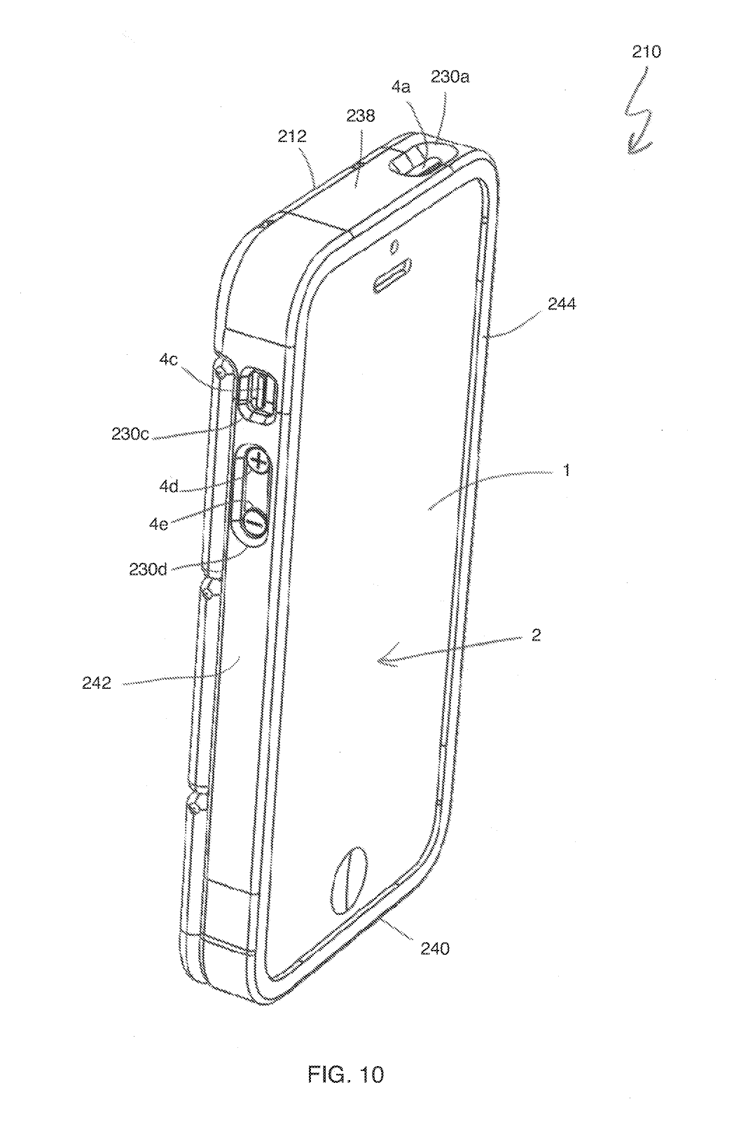

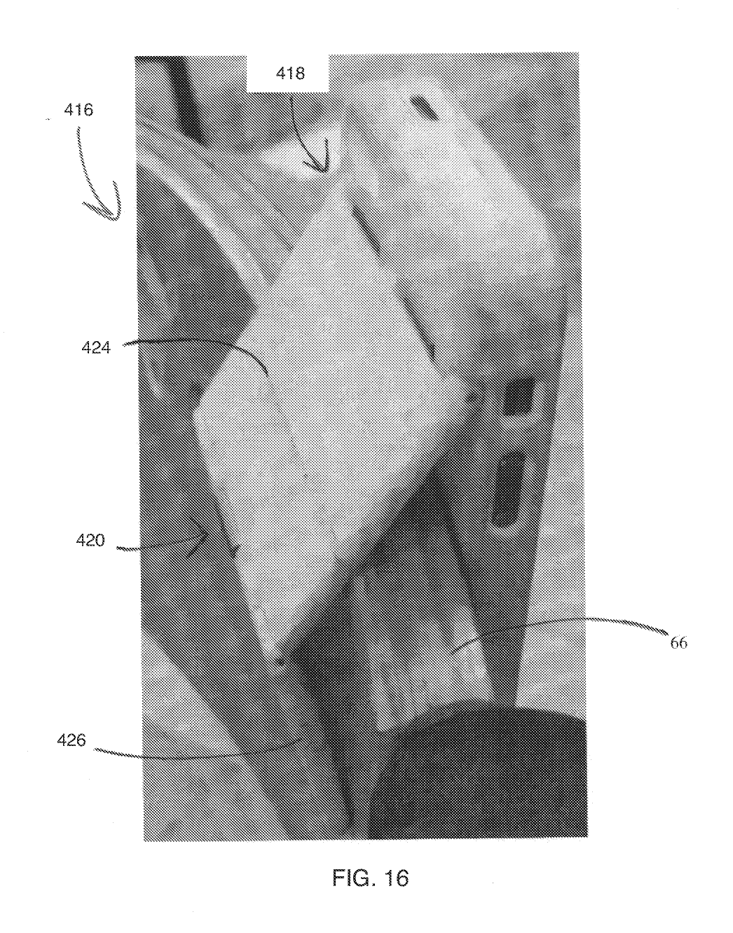

Still referring to the embodiment of FIGS. 1-4, housing 12 is configured to generally enclose a portion of a handheld computer 1 (FIGS. 10, 12, 17, 19), for example a smartphone, electronic reader, tablet computer or other similar electronic devices. Articulated assembly 16 includes a plurality of articulated members 24, 26 including a first articulated member 24 and a second articulated member 26 that are attached together by a linking joint 20 and collectively to housing 12 by a connecting joint 18. Connecting joint 18 includes a pin 28a and a double torsion spring 17, 19 and linking joint 20 includes pin 28b and torsion springs 21, 22. In a default mode or position, articulated assembly 16 is biased by springs 17, 19, 21, 22 into a flat configuration so that articulated assembly 16 flattens to form a rear surface 25 of mounting device 10. Alternatively, articulated assembly 16 is adjacent to a rear portion 34 of housing 12 when in the default position. Articulated assembly 16 can also be moveable to a propped or standing mode in which articulated assembly 16 is bent at respective hinges 18, 20 away from rear portion 34 of housing 12, so that an exterior object 66 (FIG. 16) can be placed between articulated assembly 16 and rear portion 34 of housing 12. Because articulated assembly 16 is biased towards rear portion 34 of housing 12 by a plurality of hinges 18, 20, articulated assembly 16 will act to push against the exterior item thereby clamping mounting device 10 thereto. In this way, articulated assembly 16 can be used to support mounting device 10 and therefore the attached handheld computer 1 (FIGS. 10, 12, 17, 19) from any number of exterior surfaces or items, such as bicycle handlebars, a steering wheel, or a purse strap. Further, housing 12 may include a housing cutout 30 so that mounting device 10 does not interfere with the capabilities of handheld computer 1 (FIGS. 10, 12, 17, 19). For example, housing cutout 30 can be aligned with a camera of handheld computer 1 (FIGS. 10, 12, 17, 19) allowing the camera of handheld computer 1 (FIGS. 10, 12, 17, 19) to function without obstruction.

In this embodiment, mounting device 10 has springs 17, 19, 21, 22 that tension hinges 18, 20, which bias articulated assembly 16 toward rear portion 34 of housing 12. Springs 17, 19, 21, 22 are sufficiently strong to securely clamp a handheld computer 1 (FIGS. 10, 12, 17, 19) to another object. The length and width of articulated assembly 16 is proportional to the size of housing 12 required to hold a handheld computer 1 (FIGS. 10, 12, 17, 19).

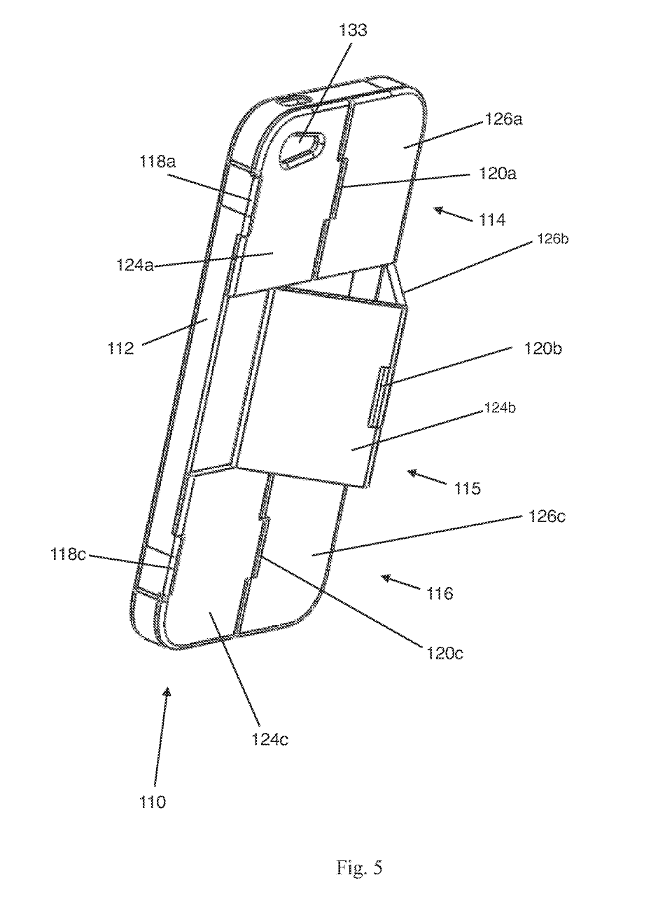

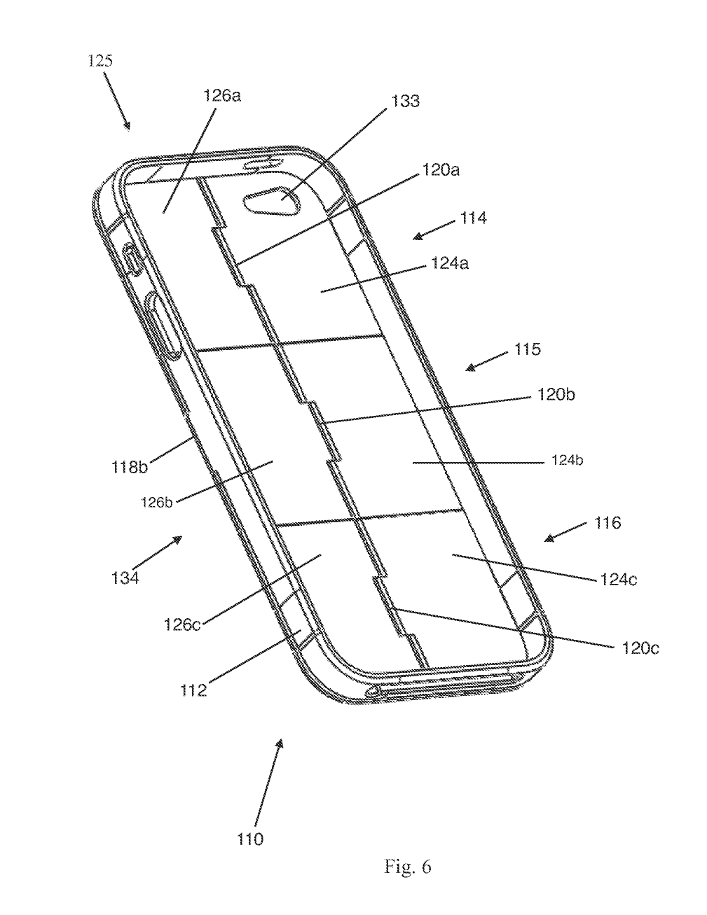

Referring now to FIGS. 5-7, a second embodiment of a mounting device 110 according to the present disclosure will be described. In this embodiment, elements shared with the first embodiment (mounting device 10) are represented by reference numerals increased by a value of 100. For example, connecting joint 18 in FIG. 1 corresponds to connecting joint 118 in FIG. 5. In the interest of brevity, some features of this embodiment that are shared with the first embodiment are numbered, but are not discussed in the specification. In this embodiment, mounting device 110 includes a housing 112 for enclosing handheld computers and also includes three articulated assemblies 114, 115, 116, each articulated assembly 114, 115, 116 includes a plurality of articulated members 124a-c, 126a-c including a first articulated member 124a-c and a second articulated member 126a-c connected by a linking joint 120a-c. Articulated assemblies 114, 115, 116, are biased to form a rear surface 125 of mounting device 110 by connecting joints 118a-c and linking joints 120a-c all having built-in torsion springs. For ease of understanding, the springs are omitted from view in FIGS. 5-7. There is shown an articulated member cutout 133 in articulated assembly 114 allowing for access to handheld computer 1 (FIGS. 10, 12, 17, 19) within mounting device 110, for example for a camera lens/camera flash, speaker, or other component that is located on the rear side of handheld computer 1. Further, there is shown a housing cutout 130 in housing 112 allowing for access to handheld computer 1 (FIGS. 10, 12, 17, 19), for example for the charging port or earphone port that is located on the bottom side of the handheld computer 1.

In more detail, still referring to the embodiment of FIGS. 5-7, mounting device 110 as shown includes housing 112 for enclosing handheld computer 1 (FIGS. 10, 12, 17, 19) therein, for example a smartphone or tablet computer. Mounting device 110 includes three articulated assemblies 114, 115, 116. In a default position, articulated assemblies 114, 115, 116 are biased by a plurality of hinges 118a-c, 120a-c into a flat configuration against mounting device 110 so that articulated assemblies 114, 115, 116 collectively form rear surface 125 of mounting device 110. Articulated assemblies 114, 115, 116 can also be bent at their respective hinges 118a-c, 120a-c and also be bent away from the rear side of mounting device 110, so that an exterior object 66 (FIG. 16) can be placed between articulated assemblies 114, 115, 116 and the rear of mounting device 110. Because articulated assemblies 114, 115, 116 are biased towards the rear of mounting device 110 by their respective hinges 118a-c, 120a-c, articulated assemblies 114, 115, 116 will act to clamp the rear of mounting device 110 to an exterior object 66 (FIG. 16) that is placed underneath articulated assemblies 114, 115, 116. In this way, articulated assemblies 114, 115, 116 can be used to support mounting device 110 and therefore the attached device from any number of exterior surfaces or items, such as those noted above.

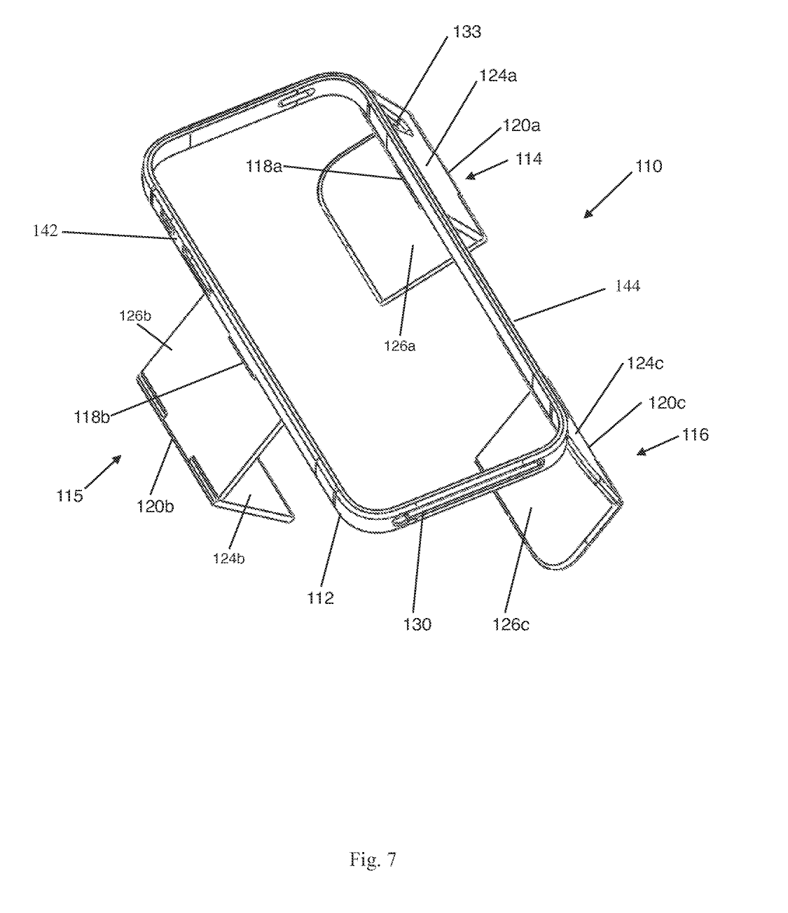

In further detail, still referring to the embodiment of FIGS. 5-7, mounting device 110 as shown contains springs (not shown) that tension hinges 118a-c, 120a-c which bias articulated assemblies 114, 115, 116 toward the rear of mounting device 110. The springs are sufficiently strong to securely clamp a handheld computer 1 (FIGS. 10, 12, 17, 19) to another object. The articulated nature of articulated assemblies 114, 115, 116 allow them to articulate around objects, such as exterior object 66 (FIG. 16), placed between articulated assemblies 114, 115, 116 and the rear of mounting device 110. The length and width of articulated assemblies 114, 115, 116 are proportional to the size of housing 112 required to hold handheld computer 1 (FIGS. 10, 12, 17, 19). In this embodiment, articulated assemblies 114, 115, 116 are attached to housing 112 at a first and a second side portions 142, 144 in an alternating fashion to allow for an opposing clamping method for added security. As shown in FIG. 7, articulated assemblies 114, 116 are attached to a second side portion 144 of housing 112 while articulated assembly 115 is attached to a first side portion 142 of housing 112 so that the biasing of each of the respective articulated assemblies 114, 115, 116 will result in opposing forces for claiming an external object 66 between articulated assemblies 114, 115, 116 and the rear of housing 112. In this embodiment, articulated assemblies 114, 115, 116 collectively form a rear surface 125 of mounting device 110.

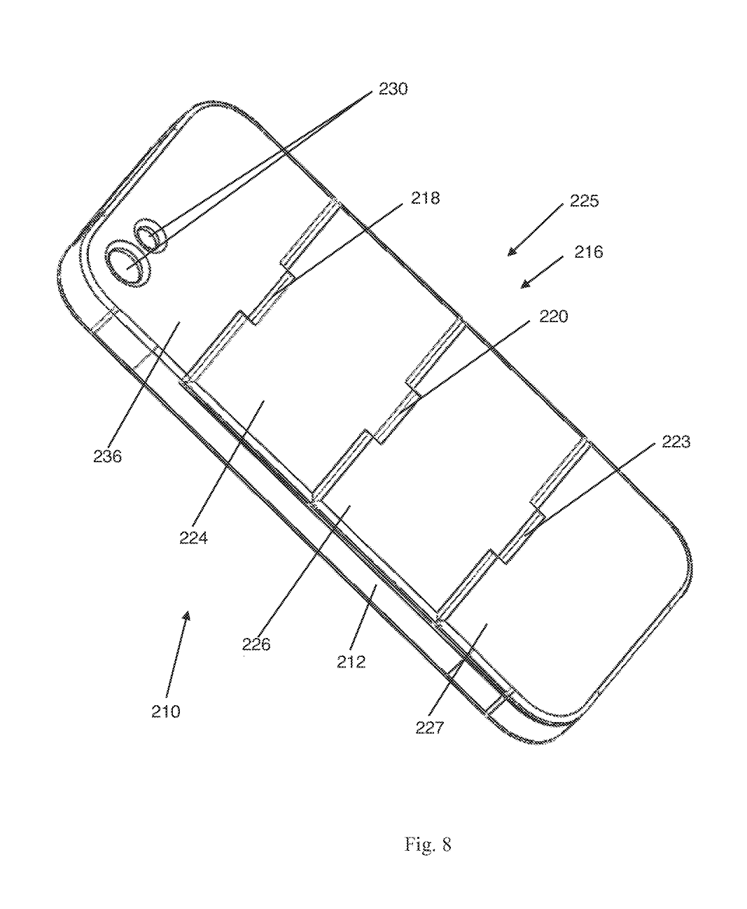

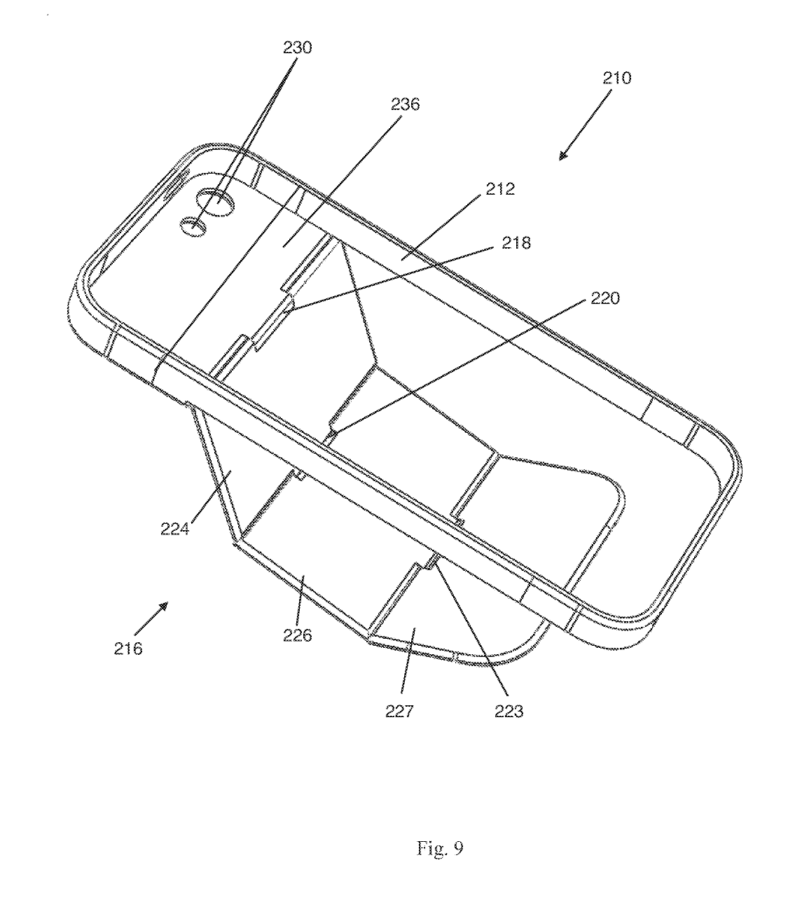

Referring now to FIGS. 8 and 9, a third embodiment of a mounting device 210 according to the present disclosure is described. In this embodiment, elements shared with the first embodiment (mounting device 10) are represented by reference numerals increased by a value of 200. For example, connecting joint 18 in FIG. 1 corresponds to connecting joint 218 in FIGS. 8 and 9. In the interest of brevity, some features of this embodiment that are shared with the first embodiment are numbered in FIGS. 8 and 9, but are not discussed in the specification. In this embodiment, there is shown a mounting device 210 including a housing 212 for enclosing handheld computers, for example a smartphone or tablet computer. Mounting device 210 also includes a top section 236 of rear surface 225 of mounting device 210 and an articulated assembly 216 that is biased toward the rear of housing 212 by a plurality of hinges 218, 220, 223. In this embodiment, there is a housing cutout 230 in top section 236 of rear surface 225 of mounting device 210 that allows for the elements of the handheld computer to properly function.

In more detail, still referring to the embodiment of FIGS. 8 and 9, mounting device 210 includes articulated assembly 216 that includes a plurality of articulated members 224, 226, 227 including a first articulated member 224, a second articulated member 226, and a third articulated member 227. In a default position, articulated assembly 216 is biased by hinges 218, 220, 223 into a flat configuration so that articulated member 216 flattens to form a rear surface 225 of mounting device 210. Articulated assembly 216 can be bent at its respective hinges 218, 220, 223 and bent away from the rear of housing 212, so that an exterior object, such as exterior object 66 (FIG. 16), can be placed between articulated assembly 216 and the rear of housing 212. In this way, articulated assembly 216 can be used to support mounting device 210 and therefore handheld computer 1 (FIGS. 10, 12, 17, 19) from any number of exterior surfaces or items. Articulated assembly 216 can also be bent inwardly toward itself to create a stand for holding mounting device 210 in various orientations on a flat surface.

In further detail, still referring to the embodiment of FIGS. 8 and 9, mounting device 210 as shown has springs (not shown) that tension hinges 218, 220, 223 which bias articulated assembly 216 toward the rear of housing 212 with sufficient force to clamp mounting device 210 with a handheld computer 1 (FIGS. 10, 12, 17, 19) contained within housing 212 to an external object 66 (FIG. 16) securely. Articulated assembly 216 is connected to housing 212 by its connection to top section 236 of rear surface 225 of mounting device 210, which in this embodiment is connected directly to housing 212. In this embodiment, articulated assembly 216 does not form the entirety of rear surface 225 of mounting device 210, but partially forms rear surface 225 of mounting device 210. In alternate embodiments, top section 236 of rear surface 225 of mounting device 210 may be integrally formed with housing 212.

Referring now to FIGS. 10-12, a fourth embodiment of a mounting device 210 for supporting a handheld computer 1, for example a smartphone or tablet computer, according to the present disclosure will be described. In this embodiment, elements shared with the first embodiment (mounting device 10) are represented by reference numerals increased by a value of 200. For example, connecting joint 18 in FIG. 1 corresponds to connecting joint 218 in FIGS. 10-12. In the interest of brevity, some features of this embodiment that are shared with the first embodiment are numbered in FIGS. 10-12, but are not discussed in the specification. In this embodiment, mounting device 210 includes a housing 212 that is sized and shaped to accommodate a specific handheld computer 1. Handheld computer 1 includes a front (screen) side 2, a rear side 3 that opposes front side 2, and a plurality of device interface objects 4a-f including buttons, a camera/camera flash, and a speaker port. Housing 212 includes a top portion 238 including a cutout 230a that is sized and shaped to not interfere with object 4a, a bottom portion 240 including a cutout 230b that is sized and shaped to not interfere with object 4b, a first side portion 242 including cutouts 230c, d that are sized and shaped to not interfere with objects 4c, d, e, respectively, a second side portion 244, a top section 236 of rear surface 225 of mounting device 210 including a cutout 230e that is sized and shaped to not interfere with object 4f, and a rear portion 234. Rear portion 234 includes a front side 246 that is located adjacent to or in close proximity to rear side 3 of handheld computer 1 when handheld computer 1 is mounted in housing 212, and a rear side 248.

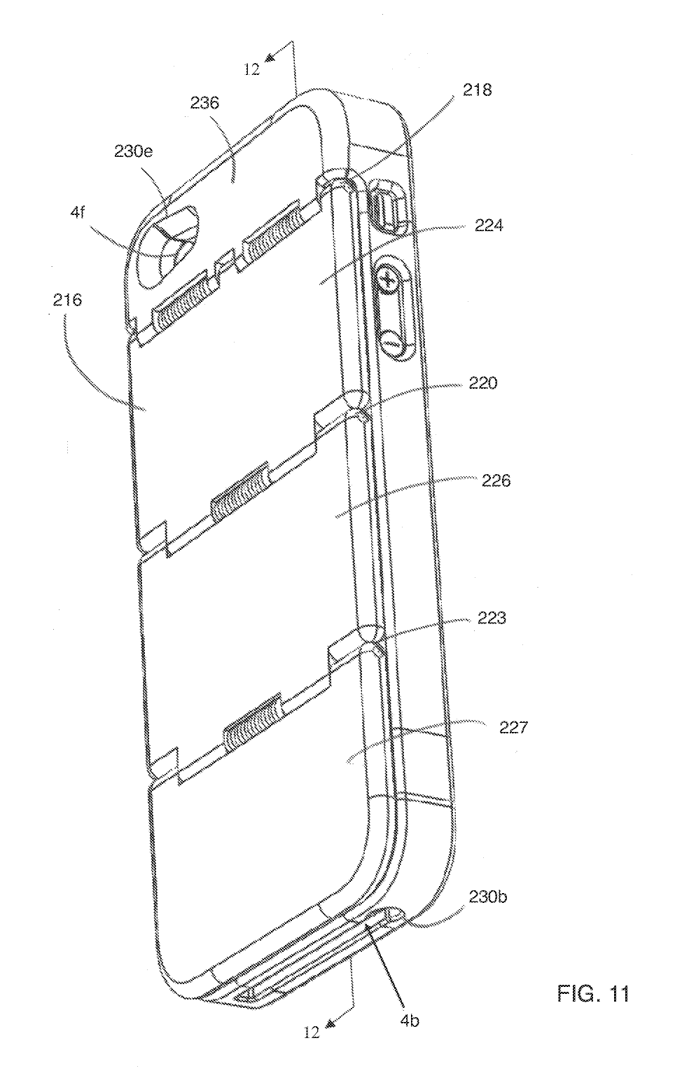

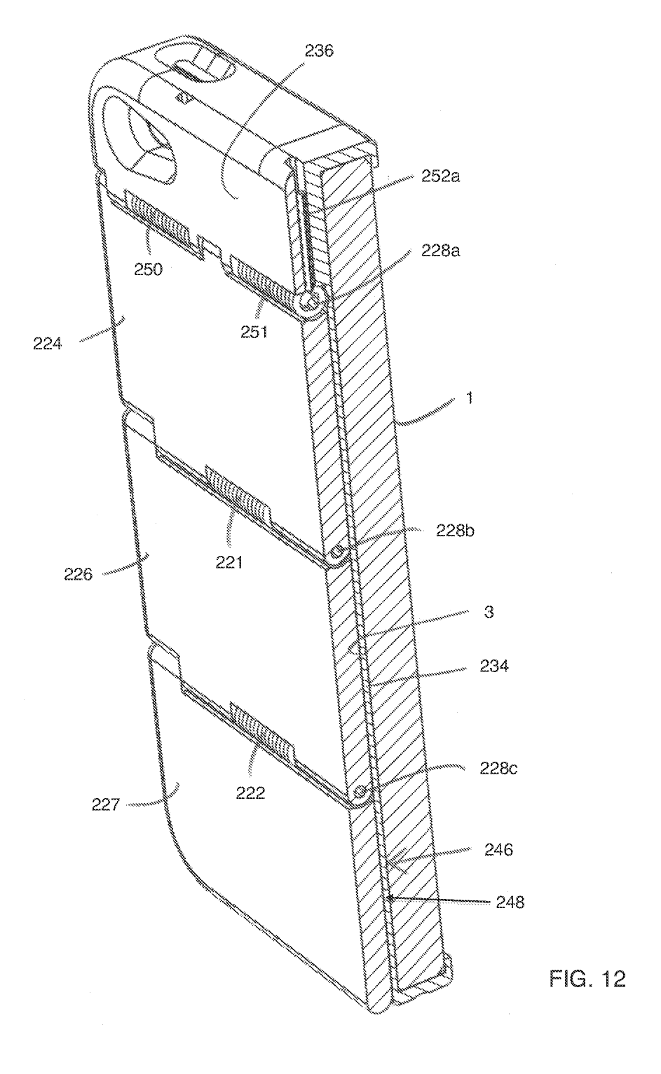

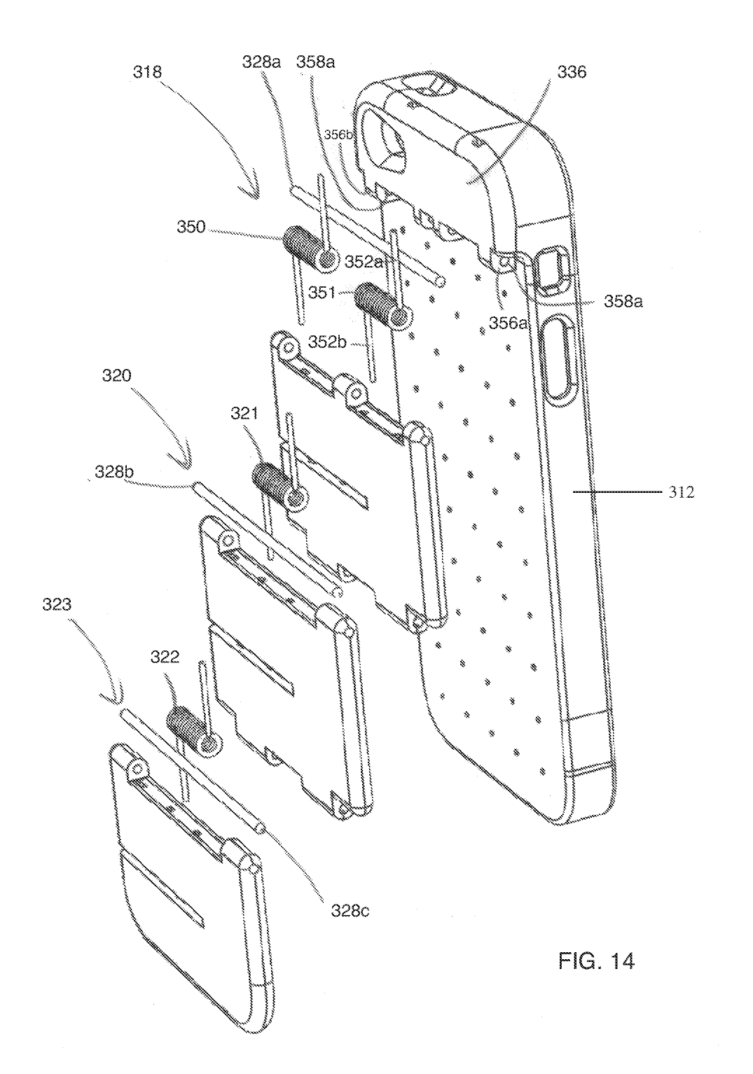

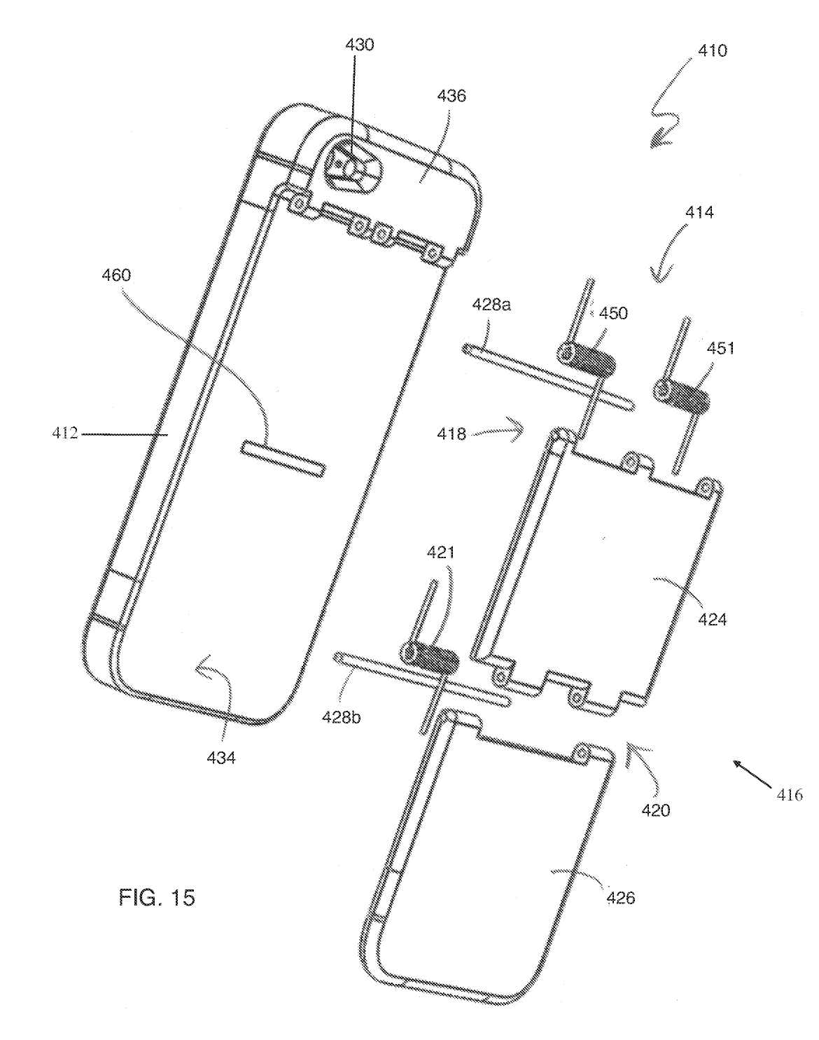

As shown in FIGS. 11 and 12, attached to housing 212 is an articulated assembly 216 including a plurality of articulated members 224, 226, 227 including a first articulated member 224, a second articulated member 226, and a third articulated member 227 that are attached together by linking joints 220, 223 and collectively to housing 212 by a connecting joint 218. Connecting joint 218 includes pin 228a, linking joint 220 includes pin 228b, and linking joint 223 includes pin 228c. As discussed above, articulated assembly 216 is biased into a flat configuration shown in FIGS. 11 and 12 by the operation of springs 250, 251 that form a portion of connecting joint 218, spring 221 that forms a portion of linking joint 220, and spring 222 that forms a portion of linking joint 223. As best seen in FIG. 12 (see also exploded views of FIGS. 14 and 15 showing the full springs of other embodiments), the legs (e.g., leg 252a of spring 251) of various springs 221, 222, 250, 251 are embedded within at least one of mounting device 210 and articulated members 224, 226, 227 to which the respective spring is located adjacent.

Articulated assembly 216 includes a plurality of hinges 218, 220, 223. The plurality of hinges 218, 220, 223 include a distal hinge and a proximal hinge(s) relative to connecting joint 218. As discussed above, hinges that are proximal to connecting joint 218 are biased more to at least partially form the rear surface 225 of mounting device 210 than hinges that are distal to connecting joint 218. In this embodiment, connecting joint 218 generates the greatest amount of restorative force, linking joint 220 generates a lesser amount of restorative force, and linking joint 223 generates the lowest amount of restorative force. This ensures that articulated assembly 216 returns to its flat, default position when not being acted on by outside forces.

In this embodiment, the pair of springs 250, 251 that at least partially form connecting joint 218 are equal in size and strength, and each imparts an equal amount of restorative force to articulated member 224. The legs of springs 250, 251 have equal free positions, therefore these legs must be deflected the same distance to be installed within connecting joint 218. Spring 221 of linking joint 220 is equal in size and strength to springs 250, 251 of connecting joint 218. The free position of the legs of spring 221 is equal to those of springs 250, 251, and therefore the legs of spring 221 must be deflected the same distance in order to be installed within linking joint 220. In this arrangement, the combined restorative force that is imparted by springs 250, 251 to articulated member 224 when installed and in their default positions has a value that is exactly twice the value of the restorative force that is imparted by spring 221 to articulated member 226 when installed and in its default position.

Spring 222 is less stiff than springs 221, 250, 251, therefore spring 222 imparts a restorative force to articulated member 227 having a value that is less than that imparted by spring 221 to articulated member 226.

In this embodiment, because articulated member 227 includes the distal end of articulated assembly 216 is under the least amount of tension, it is capable of being bent away from rear portion 234 of housing 212 or handheld computer 1 at linking joint 223 without affecting the other articulated members 224, 226 included in articulated assembly 216. This allows for the distal-most articulated member 227 to be pried up by the user's finger to allow for a gap to open between the end of articulated assembly 216 and rear portion 234 of housing 212 or handheld computer 1 so that exterior objects may be slid into the gap and then subsequently underneath the more proximal portions of articulated assembly 216, which are under more tension. This feature enhances the usability of articulated assembly 216 in applications such as mounting device 210 onto a belt or fabric-based object.

In this embodiment, springs 221, 222, 250, 251 are torsional springs. In alternate embodiments, the springs could be double-torsional springs or other suitable known types of biasing means. In further alternate embodiments, the hinges could include detent hinges, wire forms, spring clips, flexible plastic components, or other suitable known biasing means, as would be appreciated by one of ordinary skill in the art. Whatever their type, the springs are selected to be sufficiently strong to both securely clamp to and support mounting device 210 and enclosed handheld computer 1 from another object and return articulated assembly 216 to its flat, default configuration when not being acted on by exterior forces.

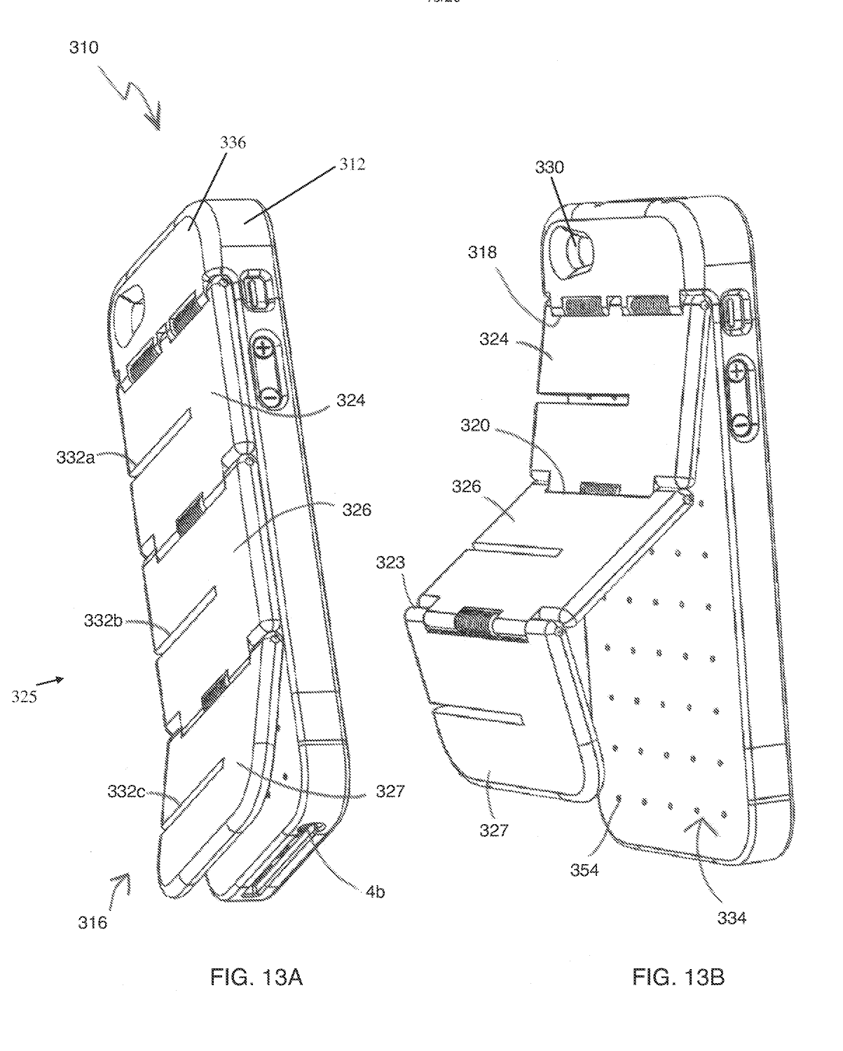

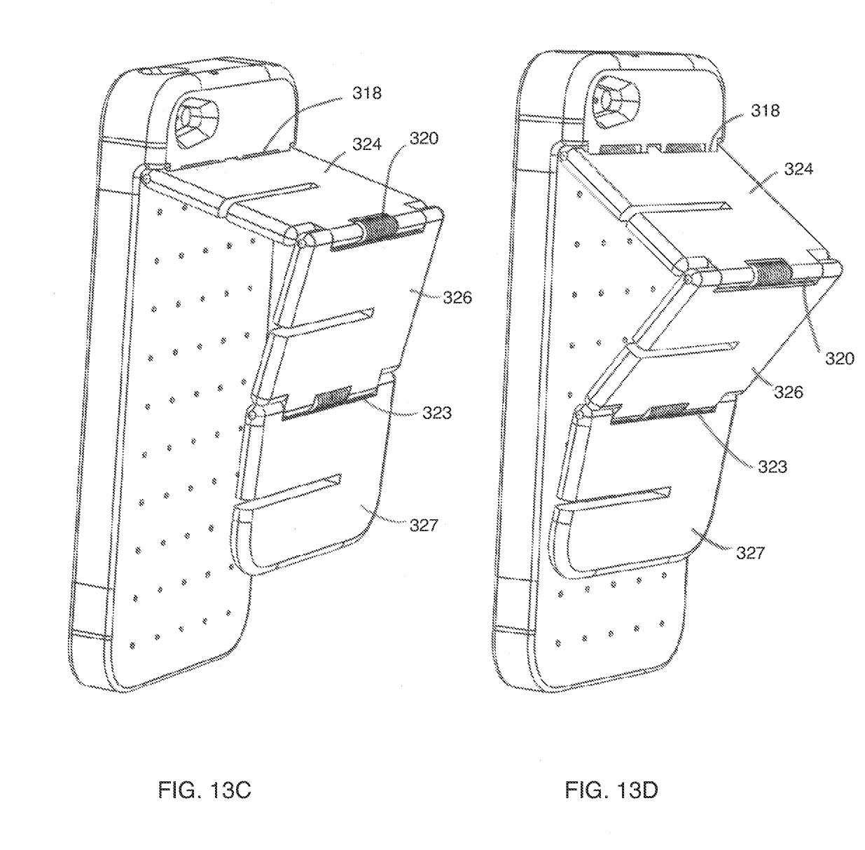

FIGS. 13A-14 show a fifth embodiment of a mounting device 310 according to the present disclosure. In this embodiment, elements shared with the first embodiment (mounting device 10) are represented by reference numerals increased by a value of 300. For example, connecting joint 18 in FIG. 1 corresponds to connecting joint 318 in FIGS. 13A-14. In the interest of brevity, some features of this embodiment that are shared with the first embodiment are numbered in FIGS. 13A-14, but are not discussed in the specification. In this embodiment, mounting device 310 includes a housing 312 and an articulated assembly 316. Articulated assembly 316 includes a plurality of articulated members 324, 326, 327 including a first articulated member 324, a second articulated member 326, and a third articulated member 327. First articulated member 324 includes an articulated member opening 332a located therein, second articulated member 326 includes an articulated member opening 332b located therein, and third articulated member 327 includes an articulated member opening 332c located therein. As discussed above, articulated member openings 332a-c make it such that the user can place, weave, or route therethrough certain exterior objects, for example a notebook, purse strap, belt, or pocket, thereby increasing the likelihood that the object will not come loose from mounting device 310.

In this embodiment, rear portion 334 of housing 312 includes a material 354 that enhances the gripping ability of mounting device 310, as discussed in detail above. As discussed above, the rear side and/or the front side of articulated members 324, 326, 327 may be partially or fully comprised of a textured material or have a textured material applied to it, or may be formed having a partially or completely studded, scalloped, undulating, porous, rough, or otherwise uneven surface for the purpose of enhancing the friction between articulated assembly 316 and an exterior object 66 (FIG. 16) located between articulated assembly 316 and rear portion 334 of housing 312. Clamping mounting device 310 to the user's hand will help the user more securely hold handheld computer 1 (FIGS. 10, 12, 17, 19) in a desired configuration, for example while writing e-mails or text messages, playing a game, or recording audio or video.

In the embodiments shown in this application, top section 336 of rear surface 325 of mounting device 310 includes a housing cutout 330 for the camera and camera flash of handheld computer 1 (FIGS. 10, 12, 17, 19). Providing this portion of housing 312 as integral is desirable in some embodiments so that the user's hand cannot block the camera when placed under articulated assembly 316. In alternate embodiments, top section 336 of rear surface 325 of mounting device 310 could be omitted, and articulated assembly 316 could form the rear of mounting device 310.

As shown in FIGS. 13A-13D, articulated member 316 can be bent at its respective hinges 318, 320, 323 away from rear portion 334 of housing 312, so that an exterior object 66 (FIG. 16) can be placed between articulated assembly 316 and rear portion 334 of housing 312.

Because articulated assembly 316 is biased towards rear portion 334 of housing 312 by hinges 318, 320, 323; when released, articulated member 316 will act to clamp mounting device 310 to the exterior object 66 (FIG. 16). In this way, articulated assembly 316 can be used to support mounting device 310, and the enclosed handheld computer 1 (FIGS. 10, 12, 17, 19) from any number of exterior surfaces or objects, such as bicycle handlebars, a steering wheel, a belt, a pocket, a purse strap, or the user's hand. FIGS. 13A-13C show various phases of articulated assembly 316 as it is being pulled away from rear portion 334 of housing 312, and FIG. 13D shows articulated assembly 316 in the process of returning to its default, flat position against rear portion 334 of housing 312.

FIG. 14 shows an exploded view of mounting device 310. Top section 336 of rear surface 325 of mounting device 310 includes four bosses 356, each of which includes a bore 358 routed therethrough, for receipt of pin 328a. For purposes of clarity, in this figure not all parts of each spring and articulated member are labeled, and only bosses 356a, 356b and bores 358a, 358b are labeled. In this embodiment, in order to assemble connecting joint 318, pin 328a is routed through the bores (including bores 356a, 356b) of top section 336 of rear surface 325 of mounting device 310, interior to the coiled portions of springs 350, 351, and through the bores of articulated member 324 Linking joints 320, 323 are assembled in a similar fashion, as would be appreciated by one of ordinary skill in the art. The legs of each of springs 321, 322, 350, 351 (including legs 352a, 352b of spring 351) are cast or otherwise molded into top section 336 of rear surface 325 and/or respective articulated member(s) 324, 326, 327. In alternate embodiments, the legs of springs 321, 322, 350, 351 need not be fully or partially located interior to any of these components of articulated assembly 316. It should be understood that, in FIGS. 14 and 15, the legs of the respective springs are shown in their biased, collinear positions as they would be located when placed under tension when mounted within the respective hinges. When in an unbiased state, the legs of the springs would return to their free positions (not shown), in which the legs of the springs are not collinear. In some embodiments, one of the legs of each of the springs would need to be rotated 135 degrees from its free position in order to place the legs of the spring in the collinear position shown in these figures.

FIGS. 15-17 show a sixth embodiment of a mounting device 410 according to the present disclosure. In this embodiment, elements shared with the first embodiment (mounting device 10) are represented by reference numerals increased by a value of 400. For example, connecting joint 18 in FIG. 1 corresponds to connecting joint 418 in FIGS. 15-17. In the interest of brevity, some features of this embodiment that are shared with the first embodiment are numbered in FIGS. 15-17, but are not discussed in the specification. In FIG. 16, mounting device 410 is shown connected to an exterior object 66, which has been located between a rear portion 434 of a housing 412 and an articulated assembly 416. In this embodiment, articulated assembly 416 of mounting device 410 includes two hinges 418, 420 and two articulated members 424, 426, and rear portion 434 of housing 412 includes a recess 460 located therein. Springs 450, 451, 421 provide bias to articulated members 424, 426.

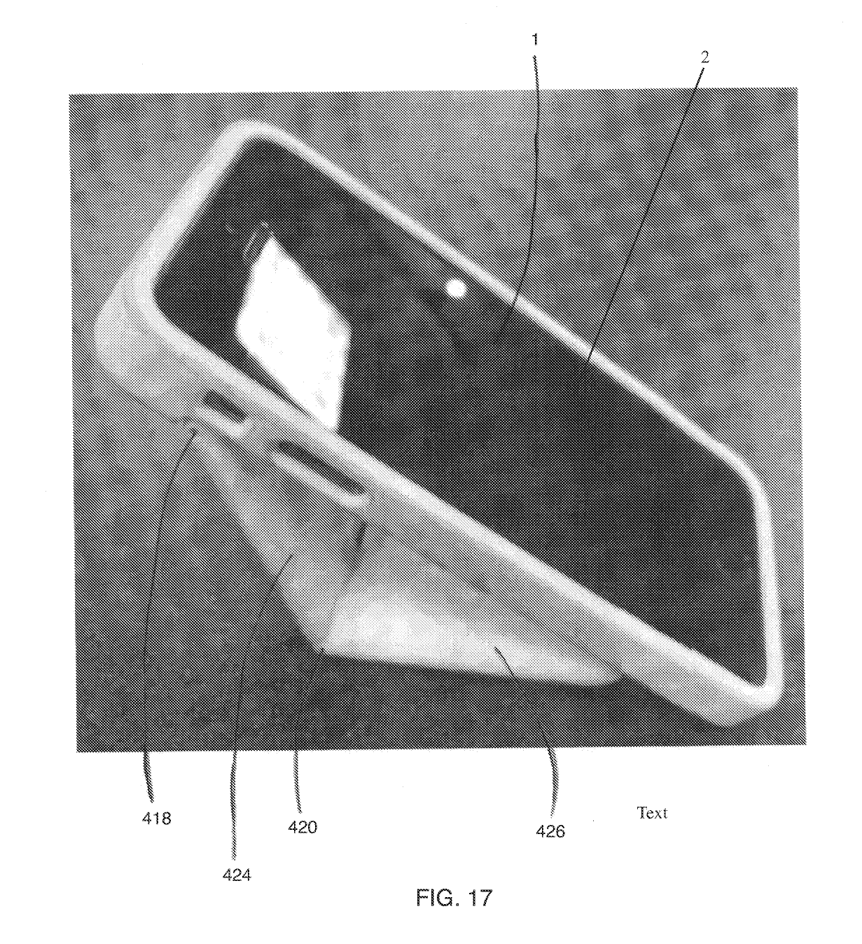

As shown in FIG. 17, this embodiment of mounting device 410 is capable of being placed in a standing or propped position in which a distal end of articulated member 426 is received within recess 460 located on rear portion 434 of housing 412. In this arrangement, owing to the biasing of hinges 418, 420, enclosed handheld computer 1 can be placed in a standing or propped position on a desktop or other surface, for ease of viewing front side 2 of handheld computer 1. To remove mounting device 410 from a standing position, the user would pull articulated member 426 in a direction away from recess 460, thereby releasing the end of articulated member 426 from recess 460.

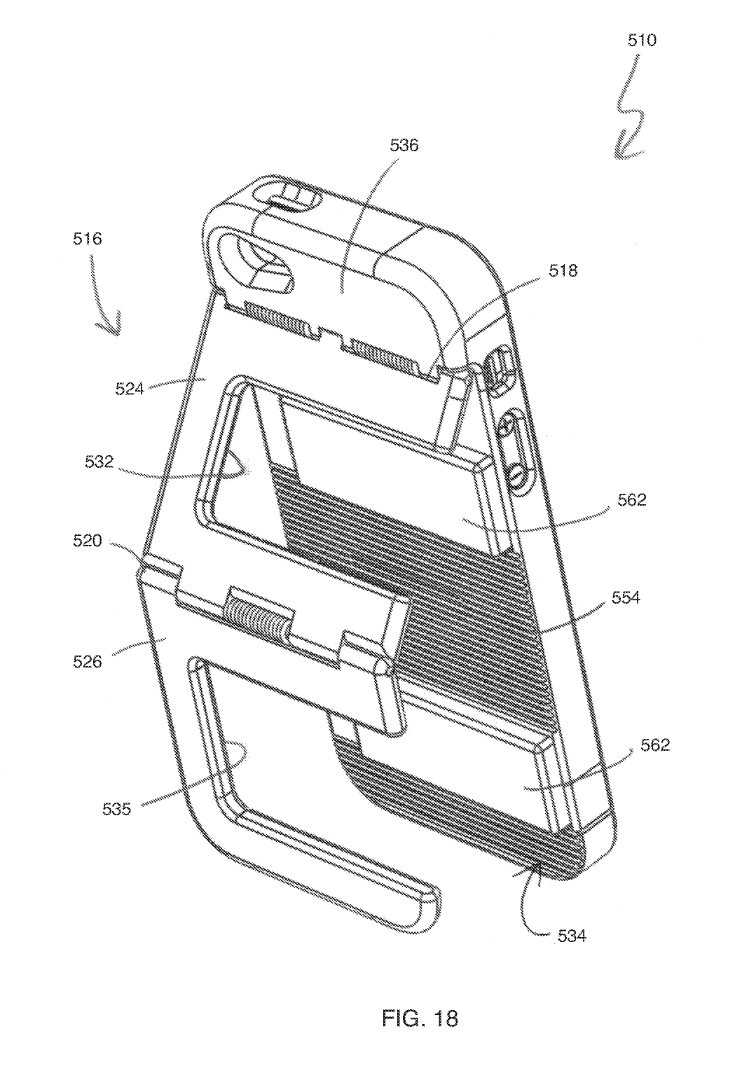

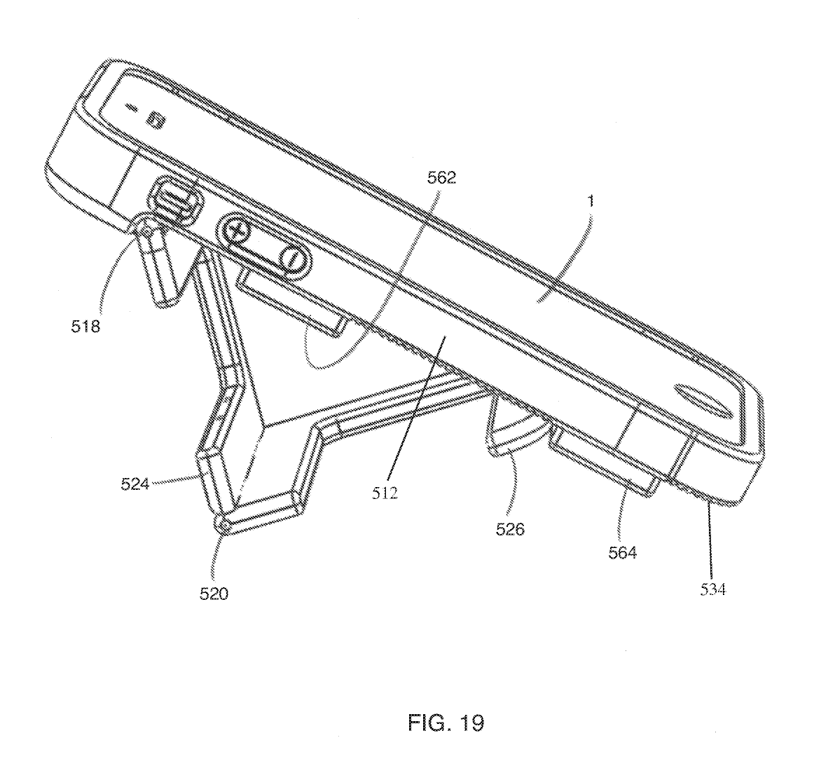

FIGS. 18 and 19 show a seventh embodiment of a mounting device 510 according to the present disclosure. In this embodiment, elements shared with the first embodiment (mounting device 10) are represented by reference numerals increased by a value of 500. For example, connecting joint 18 in FIG. 1 corresponds to connecting joint 518 in FIGS. 18 and 19. In the interest of brevity, some features of this embodiment that are shared with the first embodiment are numbered in FIGS. 18 and 19, but are not discussed in the specification.

In this embodiment, articulated assembly 516 of mounting device 510 includes a plurality of hinges 518, 520 and a plurality of articulated members 524, 526. A first articulated member 524 includes an articulated member opening 532 and a second articulated member 526 includes an articulated member opening 535. Rear portion 534 of housing 512 includes a pair of protrusions 562, 564 that are aligned with and sized slightly smaller than articulated member openings 532, 535 when articulated assembly 516 is in its flat, default configuration. Rear portion 534 also includes a material 554 for enhancing the gripping ability of mounting device 510, as discussed above with respect to other embodiments of the present disclosure. The relatively large size of articulated member openings 532, 535 allows for larger items to be routed therethrough than is possible if only a thin opening is removed from the articulated members.

As shown in FIG. 19, this embodiment of mounting device 510 is capable of being placed in a standing or propped position in which the distal end of articulated member 526 is placed on top of protrusion 564 located on rear portion 534 of housing 512. In this arrangement, owing to the biasing of hinges 518, 520, enclosed handheld computer 1 can be placed in a standing or propped position on a desktop or other surface, for ease of viewing front side 2 of handheld computer 1. To remove mounting device 510 from this standing position, the user would pull articulated member 526 in a direction away from and clear of protrusion 564.

In all of the embodiment of the disclosure described above, mounting devices 10, 110, 210, 310, 410, 510 may be integral with the handheld computer to support the remainder of the handheld computer. Further, housing 12, 112, 212, 312, 412, 512 may be one and the same and/or integral with the handheld computer housing so that it is a housing that is configured to support the handheld computer.

Additionally, in all of the embodiments of the disclosure described above, mounting devices 10, 110, 210, 310, 410, 510 may be made of plastic, metal, or of any other sufficiently rigid and strong material such as wood, and the like. Further, the various components of mounting devices 10, 110, 210, 310, 410, 510 can be made of different materials. Further, the method of biasing the articulated member(s) toward the rear of the housing can be achieved by a variety of mechanical tensioning components, including but not limited to torsion springs, double torsion springs, wire forms, or metal spring clips. Flexible plastic components can also be used to provide tension on the hinges.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

What is claimed is:

1. A mounting device for supporting a handheld computer, the mounting device including:
a housing that is operationally configured to support the handheld computer, the housing having a top portion, a bottom portion, a first side portion, and a second side portion; and
at least one articulated assembly attached to the housing through a connecting joint, the at least one articulated assembly including a plurality of articulated members, a first of the plurality of articulated members being biased to at least partially form a rear surface of the mounting device, and a second of the plurality of articulated members being positioned distal to the first of the plurality of articulated members relative to the connecting joint.

2. The mounting device of claim 1, wherein the housing includes a rear portion.

3. The mounting device of claim 2, wherein the rear portion of the housing further includes a textured material.

4. The mounting device of claim 1, wherein the housing includes a cutout which maintains access to the handheld computer for operation thereof.

5. The mounting device of claim 1, wherein at least one of the plurality of articulated members includes at least one opening that allows for an outside object to be positioned therein to support the mounting device.

6. The mounting device of claim 5, wherein the housing includes a rear portion, the rear portion includes at least one protrusion that corresponds with the at least one opening.

7. The mounting device of claim 1, further including a plurality of hinges including the connecting joint and at least one linking joint between at least two of the plurality of articulated members, the plurality of hinges including a distal hinge and a proximal hinge, the proximal hinge being biased more than the distal hinge.

8. The mounting device of claim 7, wherein the at least one linking joint is distal to the connecting joint, and the at least one linking joint includes at least one torsion spring.

9. The mounting device of claim 1, wherein the connecting joint includes at least one torsion spring.

10. The mounting device of claim 9, wherein the at least one torsion spring is a double-torsion spring.

11. The mounting device of claim 1, wherein the at least one articulated assembly is attached to the housing proximate the top portion of the housing.

12. The mounting device of claim 1, wherein the at least one articulated assembly is attached to the housing along at least one of the first side portion and the second side portion.

13. The mounting device of claim 1, wherein the plurality of articulated members include at least one cutout that keeps the mounting device from interfering with the operation of the handheld computer.

14. A mounting device for supporting a handheld computer, the mounting device including:
a housing that is operationally configured to support the handheld computer, the housing having a top portion, a bottom portion, a first side portion, a second side portion, and a rear portion, the rear portion of the housing having a recess; and
at least one articulated assembly attached to the housing through a connecting joint, the at least one articulated assembly including at least a first articulated member, a second articulated member, and a last articulated member, the second articulated member being positioned distal to the first articulated member relative to the connecting joint, and the last articulated member having a distal end, the distal end being positionable to be at least partially received in the recess of the rear portion of the housing.

15. The mounting device of claim 14, wherein at least one of the plurality of articulated members is biased to at least partially form a rear surface of the mounting device.

16. The mounting device of claim 14, further including a plurality of hinges including the connecting joint and at least one linking joint between at least two of the first, second, and last articulated members, the at least one linking joint including a distal hinge and a proximal hinge, the proximal hinge being biased more than the distal hinge.

17. The mounting device of claim 16, wherein the connecting joint and the at least one linking joint includes at least one torsion spring.

18. The mounting device of claim 14, wherein the housing further includes a cutout that keeps the mounting device from interfering with the operation of the handheld computer.

19. The mounting device of claim 14, wherein the at least one articulated assembly is attached to the housing proximate the top portion.
